(19) United States
(12) Patent Application Publication
(10) Pub. No.: US 2003/0044748 A1
(43) Pub. Date: Mar. 6, 2003

(54) Variable rigidity impression tray

(76) Inventors: Jack J. Tucker, San Antonio, TX (US); David A. Tucker, San Antonio, TX (US)

Correspondence Address: David A. Tucker, c/o Jack J. Tucker, 10306 Kings Grant Dr., San Antonio, TX, 78230, US

(21) Appl. No.: 10/228,740

(22) Filed: Aug. 27, 2002

Related U.S. Application Data
(60) Provisional application No. 60/315,640, filed on Aug. 29, 2001.

(51) Int. Cl. A61C 9/00

(52) U.S. Cl. 433/38; 433/45

(57) ABSTRACT

A dental impression tray having varying rigidity. A joint in the tray's posterior is reinforced prior to intraoral placement by a removable wire running through hooks in the tray's rim. Removing the wire after the patient bites imparts flexibility to the joint, and then the tray's frame becomes rigid intraorally when an uncured immobilizing agent previously applied to the joint is cured. The tray's initial rigidity facilitates handling; its subsequent flexibility reduces the frame's plastic memory; and its subsequent rigidity durably locks the tray into a pressure-relieved position.

### CROSS-REFERENCE TO RELATED APPLICATIONS

This application claims the benefit of Provisional Application Serial No. 60315640, titled, “Impression Tray with Removable or Temporary Reinforcement,” filed Aug. 29, 2001 by Jack J. Tucker, D.D.S.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not applicable.

### BACKGROUND OF INVENTION

1. Field of the Invention

This invention relates to dental impression trays and their method of use.

2. Description of the Related Art

Many dental and orthodontic procedures require the dentist to form an impression of the patient's teeth, either alone or in conjunction with the gums and vestibular anatomy. This impression typically is either used directly by the dentist or orthodontist to analyze the patient's mouth structure or is used to form a plaster replica of the patient's teeth, gums, and vestibule. Such impressions are typically used to produce dental replacement components and dental assemblies such as crowns, teeth, bridgework, dentures and other oral prostheses.

Dentists use trays to carry impression material to the mouth and to support the moldable material intraorally until it cures. The design of the tray depends on the size and shape of the area to be recorded. One type of dental impression tray—often referred to as a multiple impression tray, a dual arch tray, or a triple tray—is used to take impressions of both upper and lower portions of a patient's teeth and mouth and to provide concurrently an impression of the relative positions of the upper and lower teeth during a bite. It typically includes an upper trough and a bottom trough, each filled with impression material such as a setable material. The upper impression corresponds to an impression section of maxilla, the lower impression corresponds to a complimentary section of mandible, and the two complimentary impressions jointly provide an impression of the bite relationship of mandible to maxilla. In comparison to other impression-taking methods, using a dual arch tray is cheaper and faster.

Two kinds of dual arch trays are generally being marketed. One is metal with a disposable cloth or paper insert. These metal trays are expensive. They require cleaning and sterilization before reuse, which is inconvenient.

The other kind of dual arch tray is usually made of totally disposable materials such as plastic, paper, cloth, mesh, or a combination of these. The trays are inexpensive, which gives them the convenience of disposability. However, their flexibility and plastic memory can cause intraoral distortions in the impression.

In other words, the lack of complete rigidity in a tray can create a “springback” distortion transfer from the tray to the impression material on release of pressure to the tray sides, which is inadvertently applied by hard- and soft-tissue interferences at some point during the impression-making process. For example, pressure can be generated by the tongue, by occlusal forces pushing material against the tray wall, by the cheeks, or by tray impingement of gingival tissues and teeth. This pressure flexes the tray while the impression material sets, causing inaccuracies in the impression when the distorted tray attempts to return to its original shape upon removal from the mouth. An impression in a flexible frame can also be distorted by forces applied to remove the tray from the patient's mouth or during routine laboratory handling. These inaccuracies are then transferred to the master cast when it is made in the dental laboratory. See U.S. Pat. No. 5,636,985 by Simmen, et al., dated Jun. 10, 1997; U.S. Pat. No. 5,513,985 by Robertson dated May 7, 1996.

The pressure of the tray against the gingiva or other soft tissues can also be uncomfortable to the patient. This discomfort can cause the patient to open or shift his bite while the impression material is setting, which can ruin the impression.

A tray for reducing springback distortion is described in U.S. Pat. No. 5,513,985 by Robertson dated May 7, 1996. The walls of this impression tray are joined by wires which allow movement of the walls during the taking of the impression and afterwards as the impression material is being cured or set. The impression material, once set, is said to maintain the shape of the wire due to the stronger memory of the impression material over the wire, which is weaker in memory.

This alleged solution is merely a different kind of flexible tray—it strikes a different balance between rigidity and flexibility in the tray than that which is inherent to competing trays, and except for the reinforcement provided by the impression material, the tray's rigidity characteristics do not change. Like any flexible tray, it may distort upon removal from the mouth. Further, the tray's reinforcement is primarily provided by the cured impression material, which cannot be too supportive or else it will not be sufficiently rubbery to disengage from interproximal areas and other tooth structures. A cured impression held by a weak-framed tray is simply not sufficiently rigid to resist distorting forces. Even with the cured impression material reinforcing it, the tray is insufficiently rigid to withstand the rigors of ordinary laboratory handling, such as supporting the weight of dental stone when it has been poured into the impression. Further, this tray design relieves intraoral pressures in only the buccal-lingual direction.

Another technique for minimizing springback distortion is to fabricate a custom tray. See, e.g., U.S. Pat. No. 5,011,407 by Pelerin dated Apr. 30, 1991. Custom trays are well known in the art. They are time consuming, can be technique-sensitive, and use a significant quantity of expensive materials.

There is a need for a dual arch tray which is supportive during placement, which is subject to minimal springback distortion, and which is strong enough to help the impression withstand the stresses of removal from the mouth and routine laboratory handling.

### BRIEF SUMMARY OF THE INVENTION

The invention provides a dental impression tray whose rigidity can be varied during the impression-taking process. The preferred embodiment is a dual arch impression tray having a bent support wire under tension that runs through several hooks arranged along the outside of the tray's frame. It has a joint in its frame, preferably in the posterior area, to which an immobilizing agent such as an uncured composite or adhesive has been applied. The support wire is pulled free immediately after the patient bites into the impression material, which allows the two parts of the frame separated by the joint to shift in response to biting forces, tissue impingement, and other intraoral forces—thereby relieving distortion-inducing stresses in the tray. The uncured material at the joint self-cures, or is light-cured, or is cured by the application of a chemical accelerant, shortly after the patient has bitten, which permits the impression to withstand removal stresses and routine laboratory handling with minimal distortion.

It is therefore an object of the present invention to provide an improved dental impression tray.

Another object of the invention is the provision of a dental impression tray having a means of frame reinforcement that can be partially defeated during impression-taking while the impression material is still somewhat viscous.

Another object of the invention is the provision of a dental impression tray having a frame design that relieves certain forces applied to it during impression-taking.

Another object of the invention is the provision of a dental impression tray which will minimize the springback distortions created by the memory found in plastics or metals traditionally used in impression trays that have one-piece frames.

Another object of the invention is the provision of a dental impression tray which is comfortable to the patient during impression-taking.

Another object of the invention is the provision of a dental impression tray which can become flexible enough to yield to intraoral pressures yet can become strong enough to resist forces applied to its frame upon removing the tray from the mouth.

Another object of the invention is the provision of a dental impression tray which can withstand the rigors of rough laboratory handling.

Another object of the invention is the provision of a preformed dual arch dental impression tray whose frame partially adapts itself to the patient's anatomy with no appreciable memory in the frame.

Another object of the invention is the provision of a custom dual arch dental impression tray that requires only small amounts of uncured material, thereby making it cost-effective to use expensive and highly engineered materials.

Further objects and advantages of the invention will become apparent from a consideration of the drawings and ensuing description.

### BRIEF DESCRIPTION OF THE SEVERAL VIEWS OF THE DRAWING

Some of the features of the present invention which are believed to be novel are set forth with particularity in the appended claims. The present invention, both as to its organization and manner of operation, together with further objects and advantages thereof, may best be understood with reference to the following description, taken in connection with the accompanying drawings in which:

FIG. 1 is a perspective view of a preferred embodiment of the tray.

FIG. 2 is a detail view of the tray's joint.

FIG. 3 is a detail view of one of the hooks on the tray's outside rim.

### DETAILED DESCRIPTION OF THE INVENTION

1. Design of Preferred Embodiment.

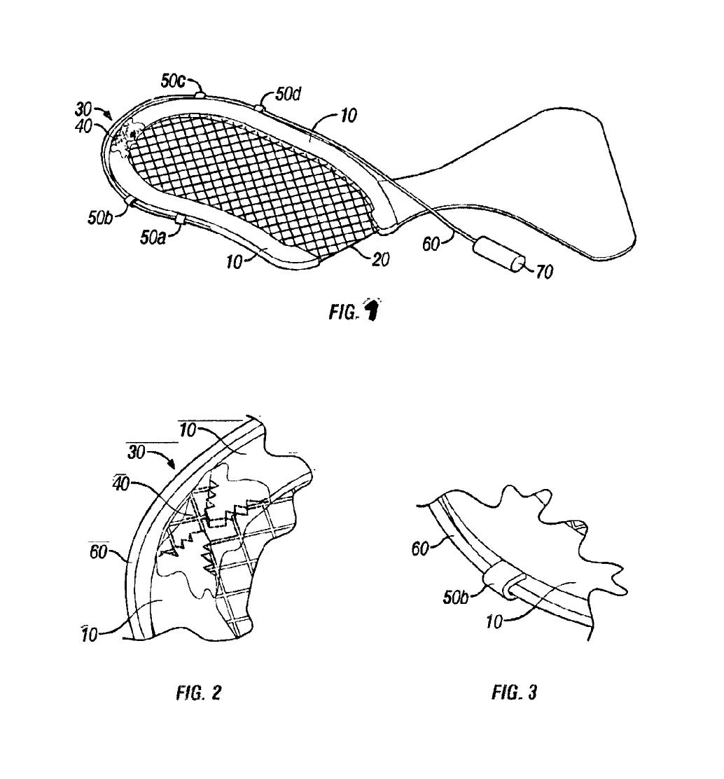

FIG. 1 shows a perspective view of the tray. In accordance with FIG. 1, the tray consists of: (a) a frame 10, preferably made of a rigid material such as plastic or metal, (b) a membrane 20 attached to or integral with the frame, which is preferably made of a close, thin, hydrophobic mesh netting (but which may also take the form of a paper, a sheet of plastic, filaments, gauze or other plastic or paper-like material), (c) a joint 30, which separates the frame into two sections that can move fairly independently, (d) an immobilizing agent 40, which is somewhat viscous and is packed through the membrane and encases the ends of the frame near the joint, (e) substantially identical hooks 50a, 50b, 50c, and 50d, which are curved projections that are integral with or attached to the frame, (e) a wire 60, which is preferably made of straight stainless steel rod which was recently bent into a curved shape, so as to pull the membrane taut and yet still retain the memory of the rod's previous shape, and which is sized to pass easily through the hooks, and (e) a grip 70, which is optional and is preferably a plastic-covered butt connector crimped onto the wire. For clarity, we show a low-walled tray, but the invention can also be embodied as a higher-walled tray.

2. Manner of Operation.

The tray is operated in the following manner. The user manually bends wire 60 from an initially straight shape in order to snap or thread it through hooks 50a, 50b, 50c, and 50d. An ordinary small-gauge stainless steel orthodontic wire has an acceptable combination of strength, smoothness, and ease of removal. The force provided by the memory in wire 60 reinforces the two sections of frame 10 so as to restrict their movement at joint 30 and so as to hold the membrane in a slightly tensioned state. This tension will later cause the membrane to provide support for the impression material as it is delivered to the mouth.

Then, the user applies an immobilizing agent 40 to joint 30 so that it encases the ends of the frame near joint 30 as well as the contiguous parts of mesh 20. Although a variety of materials will service, the immobilizing agent is preferably an uncured, mixed-two-part, self-curing dental composite. No immobilizing agent is ideal for all circumstances, however, so the user's selection of material should be guided by the following circumstances of the case: (i) expected time lag between material placement and intraoral insertion, (ii) speed of impression material cure, (iii) desired speed of dental composite cure, (iv) desired initial viscosity of the composite material, (v) anticipated ability of the patient to keep his tongue, cheek and jaw still, (vi) shrinkage during polymerization, (vii) biocompatibility, (viii) flavor, and (vii) cost.

The user then applies his preferred impression material to both sides of membrane 20 and delivers the impression-material-filled tray to the mouth. The patient bites, and the user visually verifies that the bite is satisfactory. The user then uses grip 70 to remove wire 60 from the tray and mouth with a smooth pull. The removal of wire 60 permits the two sections of frame 10 to shift at joint 30 in response to intraoral pressures applied to the frame, and immobilizing agent 40 should still be sufficiently viscous at this point to permit easy movement. Ideally, as soon as practicable after the intraoral pressure is relieved, immobilizing agent 40 should self-cure or be light-cured by the user to a rigidity sufficient to immobilize the two sections of frame 10. The user removes the impression and tray from the mouth once the impression material and immobilizing agent 40 have cured sufficiently.

3. Alternative Embodiments

The preferred embodiment of the invention described above is one of many possible ones. The tray need not have all the features described in the preferred embodiment. For example, it could be designed simply to have temporary or removable reinforcement in its frame. This would provide a tray which both (i) supports the impression material as it is being delivered to the mouth and (ii) helps remove the memory in the frame that might otherwise cause a springback distortion. Of course, in this design, the user risks that the cured impression material would not provide sufficient support to the tray during removal from the mouth or under routine laboratory handling. Alternatively, the tray's frame could be designed to be sufficiently flexible or jointed (so as to relieve intraoral stresses placed on it), while an immobilizing agent locks the frame into its stress-relieved position after the patient bites. Of course, the preferred tray combines the best of both designs—it is rigid enough to be supportive during placement, then relieves intraoral stress during use, and then becomes rigid again prior to removal to the mouth.

a. Imparting Temporary or Removable Rigidity.

There are many ways to impart temporary or removable rigidity to the tray prior to inserting it in the patient's mouth. If the tray design uses a wire for reinforcement, the position, shape, and number of the hooks can be changed. Alternatively, the wire could be passed through one or more channels, staples, tunnels, loops or tubes that are attached to or integral with the frame. For example, the membrane could be made to extend beyond the rim of the tray, and the wire could be “sewed” through it or passed through a tunnel-like looped section of membrane. Multiple support wires could also be used to impart additional reinforcement to the tray without sacrificing ease of removal. The wire itself could be made of metal or plastic. The non-grip end of the wire could also have a plastic-encased tip so as to reduce the perceived risk that pulling the wire will scratch tissues. Of course, the grip for the wire, such as a looped section of wire or an attached piece of plastic, is optional. Further, the means for removing the wire support could vary—rather than pulling the wire free, the user could manipulate the wire to unhook it from the frame and then leave it in place while the impression material cures. Alternatively, rather than use the memory in the wire to provide structural support, the wire's tensile strength could be used. In this embodiment, a wire under tension could affix two sections of the frame to each other and be severed when appropriate.

Instead of using wire, reinforcement could also be applied directly at the joint. One method would use a temporary or removable immobilizing agent. For example, the user could encase the joint in ice, chocolate, thermoplastic, or another substance which would become flexible or viscous when heated. Heat provided by oral tissues could be used to melt the material, or additional heat could be delivered by the user through a heat-transmissive structure in the tray (e.g., a resistor imbedded in the tray attached to a wire projecting from the tray's handle). If a resistor is to be used, then the meltable material could be encased in a flexible, heat-insulating structure so as to protect oral tissues. The joint could also be immobilized by providing a gas- or fluid-filled tube under pressure, engaged with the tray's frame or only its joint, that can become disengaged when popped with an instrument so as to release the enclosed pressurized air or liquid.

Another means of immobilizing the joint could be to span a pin across the joint which inserts into mating holes in both frame sections, operating in much the same way that a door latch secures a door. The pin could be metal or plastic, and to inhibit rotation around the pin it should preferably be curved along its length or have a cross section that keys into a non-round mating hole. Alternatively, the latch structure could be as simple as a thick removable pin or wire threaded or inserted through a section of the membrane that loosely loops around the posterior part of the tray's frame. Like pulling a large stick from a bundle of several small sticks, the void created by the missing pin would permit the relative movement of the two sections of frame that are within the joint. In the latch embodiment, the pin could be removed after the tray is intraorally placed by pulling it free with an instrument or by pulling an attached wire, dental floss, or long handle.

Yet another method of imparting reinforcement directly to the joint would be to mechanically hold the two sections of the frame together in a fixed relationship. This could be done by means of a clamp—such as a hemostat whose rubber-encased tip spans both sides of the joint. The clamp could even serve the function traditionally served by the handle used in traditional dual arch impression trays. A similar design would let the hand itself act as a clamp. This design would have a long, rigid, curved, metal bar that is removably attached to the lingual section of the frame. This bar would act as a second handle, and the user would manually press it into or hold it against the main handle. Also, as alluded to earlier, separated sections of the frame could be mechanically held or “clamped” together by means of a wire. This wire would attach to the far section of the frame near its end, run through or along the other frame section (which might have a guide for the wire), and either (i) be attached under tension or not to the tray's handle or (ii) be held by the user. The wire could be cut or unattached after delivery of the impression material to the mouth, which would cause the separate frame sections to disengage from each other at the joint, permitting their movement relative to each other.

Alternatively, reinforcement could be removed from the tray by creating the joint after delivering the impression material to the mouth. The user would sever the frame in its posterior section with a cutting instrument, after the patient has bitten into the impression material. The disadvantages to this method are: (i) cutting the frame would tend to disturb any immobilizing agent applied at or near the break; (ii) providing for a separate joint at or near the break to which immobilizing agent has been applied would provide undesirable bulk in the retromolar area that could interfere with the patient's bite, and (iii) the insertion or removal of the cutting instrument is likely to induce the patient to adjust his bite, thereby ruining the impression.

A variation of the cutting embodiment is to change the rigidity of the frame by applying electric current, through a wire running along or through the tray, to one or more resistors that are encased in the frame. To avoid tissue damage, the plastic around the resistor should be selected from among one of the many materials used in custom trays that become malleable at relatively low temperatures. Alternatively, if the resistor were comprised of a brittle material having a low melting point, the resistor could sever like a fuse, thereby removing support from the tray.

Yet another way of providing temporary reinforcement similar to the clamping method could be to provide U-shaped support tray on which the main tray rests which is removably engaged with the main tray. After the patient bites, the support tray could be disengaged from the main tray by a variety of methods (e.g., severing the means of connection, pulling a pin or key that latches the two structures together, removing the part of the support tray's handle that projects from the U-shaped section so that it disengages under the force of gravity). The structure can remain in the mouth until the impression material cures, if desired.

b. Imparting Rigidity to a Tray After the Bite.

There are also various ways to design a joint and immobilizing agent that will impart rigidity to a tray after the patient bites. The design and composition of the joint, of course, depends upon the means by which it is to be immobilized. For example, although a dental composite is preferred for its strength, viscosity, rapid curing, FDA approval, ease of handling, and similar factors, the immobilizing agent could also be an adhesive or gap-filling, resin-like material such as epoxy, cyanoacrylate, acrylic, two-part acrylic, two-step acrylic, silicone, polyurethane, retaining compound, low-temperature thermoplastic, threadlocking compound, glue, resin, or a similar substance. Any material that undergoes a transition from liquid state to a rigid, solid state within a few minutes could be a suitable candidate. In addition to the factors cited above, some other factors that should guide the selection of an immobilizing agent include biocompatibility, time of cure, tendency to adhere to tooth enamel, strength of cure, gap-filling capability, adhesive substrate, cost, availability of accelerators and adhesion promoters, ease of use, initial viscosity, outgassing characteristics, taste, storage methods, shelf life, preferred joint design, and pot life.

The material selected could act to immobilize the frame's separate sections by adhering them together, by locking them in an encasing, hard substance, or by both methods. Further, depending upon the kind of immobilizing agent selected, it could be self-curing, light-curing, dual curing, or accelerant-curing. If a light cure material is selected, the joint will most likely have to be moved toward the buccal side of the frame and preferably should be cured: (i) by shining a curing light through a reflective tube designed to point toward the joint when intraorally inserted or (ii) by shining a curing light through a light-transmissive tray frame. The immobilizing agent is preferably applied prior to inserting the tray in the mouth, but it could also be applied after biting by squirting it through a tube that is integral to the tray. In fact, a flexible tube itself could be used to immobilize the tray by attaching it to the frame and filling it with a curable material.

There are many ways to design a joint that will permit the frame sections to move in response to intraoral forces. The preferred embodiment describes the joint as an open, mesh-filled gap between the frame's two sections, but it could also be one or more traditional joints having a more limited range of motion—such as a prismatic joint (e.g., a key-and-keyhole joint), rotational joint (e.g., a hinge, a ball-and-socket joint, looped rings, thread-and-nut joint), or elastic joint (e.g., the two sections of frame bridged by a flexible material, or a sponge-like material soaked in immobilizing agent, or an immobilizing-agent-filled tube, or a void). As used in this application, the term “joint” is defined to also include a gap or separation in the frame. The joint could be varied in number, position and orientation so as to relieve stress from various locations and directions.

The immobilizing agent could also be direct pressure applied to the joint, rather than chemical adhesion or the bracing provided by a cured resin. For example, if the joint were to be constructed of an aluminum ball-and-socket joint, the user could use a pre-positioned instrument to crush the socket with the ball inside, thereby preventing the ball's movement. In this embodiment, the joint should be shifted to the buccal side of the frame's posterior so it is reachable without disturbing the patient's bite.

Alternatively, the same effect could be obtained by imbedding a resistor in the tray's posterior which is attached to a wire which can be used as a transmitter of electrical current. The joint or the posterior section would be made from a thermoplastic material which, after being heated and cooled by the application and removal of current to the resistor, would lock the tray into its stress-relieved position.

Thus, the reader will see that the devices and methods described above provide a means for imparting flexibility and rigidity when needed in a dual arch impression tray. Its pre-impression rigidity facilitates handling, while its flexibility during impression-taking minimizes springback distortion, while its post-cure rigidity minimizes the risk of distortions induced by impression removal and laboratory handling.

While various embodiments of the present invention have been shown and described above, it should be understood that they have been presented by way of example only, and not limitation. Many other variations are possible. It will be obvious to those skilled in the art that changes and modifications may be made without departing from the spirit of this invention in its broader aspects. Thus, the breadth and scope of the present invention should not be limited by any of the above described exemplary embodiments. The aim in the appended claims is to cover all such changes and modifications as fall within the true spirit and scope of this invention.

What is claimed is:

1. A tray for taking a dental impression comprising:
a frame having a generally “U”-shaped portion;
a membrane supported on and integral with said frame and spanning said “U”-shaped portion; and
a means for reinforcing the tray as it is used to deliver an impression material to the mouth, said means comprising an object engaged with the tray, and whereby the reinforcement effect of said means can be abated after the impression material is delivered to the mouth and while the impression material is still viscous.

2. The tray of claim 1 wherein the object is a material which is rigid at room temperature, which is engaged with the frame in the frame's posterior region, and which material will become less rigid when heated.

3. The tray of claim 1 further including a joint within the posterior region of said frame.

4. The tray of claim 1 wherein the means is comprised of a wire.

5. The tray of claim 1 wherein the means is comprised of a member connecting a part of the frame to another part of the frame, wherein such member is configured and positioned so as to permit the user to disconnect the member from one of said parts of the frame while the tray is in the patient's mouth.

6. The tray of claim 1 wherein the means is comprised of a member connecting part of the frame to another part of the frame, wherein such member is configured and positioned so as to permit the user to sever the member while the tray is in the patient's mouth.

7. The tray of claim 1 wherein the means is comprised of a latching structure which can be unlatched by the user while the tray is in the patient's mouth.

8. The tray of claim 7 wherein the latching structure comprises a component selected from the group consisting of wires, strings, rods, levers, handles and pins.

9. The tray of claim 1 wherein the means is comprised of a clamp.

10. The tray of claim 1 wherein the means is comprised of a human hand and plurality of handles engaged with different parts of the frame, which parts are not affixed to each other, whereby said hand can reinforce the tray by pressing a plurality of handles together.

11. A method for taking a dental impression comprising the steps of:
selecting a dual arch dental impression tray suitable for taking an impression of the oral structure of interest;
placing a quantity of impression material in the tray;
placing the impression-material-loaded tray in the patient's oral cavity;
causing the patient to bite into the impression material;
utilizing a means for reducing the rigidity in the tray's frame.
allowing the impression material to cure; and
removing the impression and tray from the patient's oral cavity.

12. The method of claim 11 wherein the means is utilized by severing a connection member within the tray's frame that affixes two sections of the frame together.

13. The method of claim 11 wherein the means is utilized by manipulating a component of the tray.

14. The method of claim 13 wherein the component manipulated is selected from the group consisting of wires, strings, rods, levers, handles and pins.

15. A tray for taking a dental impression comprising:
a frame having a generally “U”-shaped portion;
a membrane supported on and integral with said frame and spanning said “U”-shaped portion;
a means for imparting a rigidity to the tray which is additive to the rigidity imparted by an impression material to be used to take the impression, whereby such additive rigidity primarily takes effect after the patient has bitten into the impression material, and wherein such means comprises an object engaged with the frame in the tray's posterior region.

16. The tray of claim 15 wherein the object comprises an immobilizing agent other than the impression material to be used to take the impression.

17. The tray of claim 16 wherein the means for imparting rigidity further comprises a joint, wherein such immobilizing agent is applied and positioned relative to the joint so that when cured the immobilizing agent would impede the relative movement of the sections of the frame bridged by the joint.

18. The tray of claim 16 wherein the immobilizing agent comprises a material that is viscous when uncured but which loses viscosity when cured.

19. The tray of claim 17 wherein the immobilizing agent comprises an adhesive.

20. The tray of claim 18 whereas the material is a dental composite.

21. The tray of claim 15 wherein the means for imparting rigidity comprises a joint and a clamp, wherein the application of force by the clamp on the joint will deform the joint in a manner that hinders the relative movement of the sections of the frame bridged by the joint.

22. A method of taking a dental impression comprising the steps of:
selecting a dual arch impression tray suitable for taking an impression of the oral structure of interest;
applying a quantity of immobilizing agent to the tray and a quantity of impression material to both sides of the tray's membrane;
placing the tray along with the impression material in the patient's oral cavity;
allowing the impression material to cure sufficiently; and
removing the impression and tray from the mouth.

23. The method of claim 22 comprising the further step of facilitating the immobilizing agent's cure by one or more of the following methods: (i) shining a curing light on it, (ii) applying a chemical, and (iii) heating it.
